(19) United States
(12) Patent Application Publication
(10) Pub. No.: US 2023/0372185 A1
(43) Pub. Date: Nov. 23, 2023

(54) WEARABLE GARMENT FOR MUSCLE STIMULATION

(71) Applicant: Villanova University, Villanova, PA (US)

(72) Inventors: Qianhong Wu, Malvern, PA (US); Bo Li, Malvern, PA (US); Bchara Sidnawi, Villanova, PA (US); Yun Li, Bryn Mawr, PA (US); Qifu Wang, Bryn Mawr, PA (US)

(73) Assignee: Villanova University, Villanova, PA (US)

(21) Appl. No.: 18/319,107

(22) Filed: May 17, 2023

Related U.S. Application Data
(60) Provisional application No. 63/342,681, filed on May 17, 2022.

(51) Int. Cl. A61H 9/00; A61H 1/00

(52) U.S. Cl. CPC A61H 9/0085; A61H 1/008; A61H 2201/1253; A61H 2201/1645; A61H 2201/1654; A41D 2400/322

(57) ABSTRACT

A device for providing a therapeutic stimulus to a subject is provided. The device may comprise a material, a network of flexible cells, at least one channel, and a working material. The material may be configured to cover a portion of the subject and may have an inner surface for engaging a surface of the subject and an exterior surface facing away from the surface of the subject. The network of flexible cells may be coupled to the material and each flexible cell may have an internal cavity. The working material may be disposed within the internal cavities of the flexible cells. The at least one channel may be arranged to allow exchange of the working material between flexible cells due to application of force upon the network from movement of the surface of the subject.

### CROSS-REFERENCE TO RELATED APPLICATIONS

This application claims priority to U.S. Provisional Patent Application No. 63/342,681, filed May 17, 2022, the entirety of which is incorporated herein by reference.

### FIELD

This application generally relates to systems and methods for stimulating, therapeutic, and/or rehabilitative techniques. More specifically, this disclosure pertains to wearable devices that can provide continuous stimulating, therapeutic, and/or rehabilitative effects.

### BACKGROUND

Evidence demonstrates that early and advanced rehabilitative treatment greatly improves long-term outcomes for subjects who have suffered from various conditions, such as a stroke. Example treatments often include regular physical therapy sessions involving exercise and massage to accelerate muscle growth and nerve recovery. Physical therapy—including nerve stimulation, blood flow promoting resistance training and/or muscle massage—is known to accelerate the path to motor function recovery.

However, current resistance stimulation applications occur only at intervals, with idle periods of non-stimulation occurring in between. In addition, while health systems and technology have made it easier for professionals to deliver muscle stimulation in patients' homes, such services are not currently available to all patients and still rely on set intervals of therapy determined by the at-home program.

### SUMMARY

Various embodiments disclosed herein can be worn by a subject even when they are engaged in normal, daily activity requiring physical exertion, leading to a positive shift in the subject's long-term prognosis through continuous, passive stimulation provided by a flexible garment that can be fit tightly around a portion of the subject, such as an arm or leg that may be wrapped. Such embodiments may also be used to treat pulled muscles and other conditions, and may benefit professional sports athletes, people on fitness programs, bodybuilders, etc. in a wide range of applications.

In accordance with some embodiments, a device for providing a therapeutic stimulus to a subject is provided. The device may comprise a material, a network of flexible cells, at least one channel, and a working material. The material may be configured to cover a portion of the subject and may have an inner surface for engaging a surface of the subject and an exterior surface facing away from the surface of the subject. The network of flexible cells may be coupled to the material and each flexible cell may have an internal cavity. The working material may be disposed within the internal cavities of the flexible cells. The at least one channel may be arranged to allow exchange of the working material between flexible cells due to application of force upon the network from movement of the surface of the subject.

In accordance with some embodiments, at least one of the flexible cells may comprise a perimeter wall, an inner layer, and an outer layer. The perimeter wall may be proximate to and extending away from an exterior surface of a material engaging the subject. The inner layer may be proximate to the exterior surface of the material and coupled to the perimeter wall. The outer layer may be substantially parallel to the inner layer and displaced from the inner layer by the wall and may be coupled to the perimeter wall, and the wall, inner layer, and outer layer may define the internal cavity of the at least one flexible cell.

In accordance with some embodiments, the at least one channel may be a plurality of channels. At least one of the channels may be coupled to and extend from an opening in the perimeter wall of one cell and an opening in the perimeter wall of another cell. The channel may thereby operatively couple the internal cavity of the one cell to the internal cavity of the other cell. A working material in the internal cavity of each cell may be redistributable by pressure differentials caused by the forces resulting from the movement of the subject exerted on the inner surface of the material that is transmitted into the internal cavity of the cell.

In accordance with some embodiments, a therapeutic garment is provided. The garment may comprise a plurality of cells, a plurality of channels, and a working material. At least one of the plurality of cells may comprise a perimeter wall, an inner layer configured to be placed proximate to a subject, and an outer layer substantially parallel to the inner layer and displaced from the inner layer by the wall. The wall, inner layer, and outer layer may define an internal cavity. At least one channel of the plurality of channels may couple the internal cavity of one cell of the plurality of cells to the internal cavity of another cell of the plurality of cells. The working material may be disposed in the internal cavity of at least one of the plurality of cells and the plurality of channels. The plurality of cells, plurality of channels, and working material may form a cell pack.

In accordance with some embodiments a method for applying a therapeutic treatment to a subject is provided. The method may include attaching a therapeutic device covering to a portion of subject. The therapeutic device may comprise a material, a network of flexible cells, at least one channel, and a working material. The material may be configured to engage a portion of the subject. The network of flexible cells may be coupled to the material and each flexible cell having an internal cavity. The working material may be disposed within the internal cavities of the flexible cells. The at least one channel may be arranged to allow exchange of the working material between flexible cells due to application of force upon the network from movement of the surface of the subject. In some embodiments, moving at least a part of the portion of the subject relative to an inner layer of at least one cell may displace the at least one inner layer of that cell, raising pressure of the working fluid in the internal cavity of the cell, resulting in pressure changes to other cells of the plurality of cells. In some embodiments, moving the inner layer of at least one other cell of the plurality of cells may result from the pressure change in the at least one other cell. The movement of the inner layer of at least one other cell of the plurality of cells provides a targeted therapeutic treatment to the subject.

### BRIEF DESCRIPTION OF THE DRAWINGS

The features and advantages of the various embodiments will be more fully disclosed in, or rendered obvious by the following detailed description of the preferred embodiments, which are to be considered together with the accompanying drawings wherein like numbers refer to like parts and further wherein:

FIG. 1 illustrates a partial view of a portion of fabric including a cell pack, in accordance with some embodiments.

FIG. 2 illustrates an exploded view of a cell of the cell pack, in accordance with some embodiments.

FIG. 3 illustrates a wearable garment for positioning over a user's limb, in accordance with some embodiments.

FIG. 4 illustrates a portion of the cell pack network, in accordance with some embodiments.

FIG. 5 illustrates an exploded view of a cell of the cell pack network of FIG. 4, in accordance with some embodiments.

FIGS. 6a-6d illustrate representative pressures of a 3×3 cell pack during use, in accordance with some embodiments.

FIG. 7 is a graph illustrating the change in pressure over time of various cells during movement, in accordance with some embodiments.

FIGS. 8a-8c illustrate an apparatus and process for forming the cell pack in accordance with some embodiments.

FIGS. 9a to 9e illustrate molds in accordance with some embodiments.

FIG. 10 illustrates an embodiment for securing a cell pack in a shape suitable for use with a subject.

FIG. 11 illustrates another embodiment for securing a cell pack in a shape suitable for use with a subject.

FIG. 12 illustrates another embodiment for securing a cell pack in a shape suitable for use with a subject.

FIG. 13 illustrates an embodiment for attaching a securing mechanism to a cell pack.

### DETAILED DESCRIPTION

The description of the preferred embodiments is intended to be read in connection with the accompanying drawings, which are to be considered part of the entire written description of this disclosure. The drawing figures are not necessarily to scale and certain features of the embodiments may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship.

As used herein, the term “substantially” denotes elements having a recited relationship (e.g., parallel, perpendicular, aligned, etc.) within acceptable manufacturing tolerances. For example, as used herein, the term “substantially parallel” is used to denote elements that are parallel or that vary from a parallel arrangement within an acceptable margin of error, such as +/−5°, although it will be recognized that greater and/or lesser deviations can exist based on manufacturing processes and/or other manufacturing requirements.

In some embodiments, a material including a network of flexible cells (referred to herein as a “cell pack”) filled with, e.g., a fluid, is disclosed. The network of flexible cells is configured to provide muscle stimulation and/or a massage effect (collectively and individually sometimes referred to herein as “therapeutic stimulus”) to an underlying structure, such as a muscle, in contact with the fabric. For example, the material including the network of flexible cells may be formed into a garment (or portion of a garment) covering a limb of a user. When the user moves a respective limb covered by the cell pack, the fluid or other material within the flexible cells is redistributed due to the local forces applied to the cell pack by the joint or other body part. Redistribution of the material (e.g., fluid) within the flexible cells propagates pressure about the underlying structure, such as a joint and related muscles, providing a passive targeted massage effect to the muscles. Such stimulation and/or massage effect may be used in physical therapy treatment, treatment of pulled muscles, strength training, etc. In some embodiments, the cell pack is integrated into a customizable, wearable device that simultaneously provides resistance and massage stimulation, for example, to promote muscle recovery. In some embodiments, a cell pack is configured to provide controlled compression and exercise of a predetermined set of muscles and/or joints.

In various embodiments, a material including a cell pack is configured to be tightly fit around a portion of a user to provide continuous resistance stimulation. The material may be formed into a wearable garment including one or more portions configured to be tightly fit around one or more predetermined portions of a user, such as, for example, one or more arms, legs, and/or other body portion(s). Portions of the material including the cell pack that cross over and/or interact with a joint (e.g., an elbow or knee joint) provide continuous resistance stimulation to operation of the respective joint during daily use.

The material including the cell pack may be configured to interface with a predetermined portion of a user's physiology. For example, in some embodiments, the material including the cell pack may be formed into and/or integrated with a garment that is configured to partially cover at least a portion of a user's extremity, such as, for example, an arm or a leg. In some embodiments, a garment, for example, a shirt, may include one or more portions including a material having one or more cell pack and portions including a traditional fabric material. In some embodiments, the garment includes a low-profile, smart garment—where the motion of the material within the cell pack (e.g., a fluid or gel), is driven the muscle contraction and the resulting compression of the cells—configured to be worn under additional clothing or material.

In some embodiments, the material including at least one cell pack is configured to provide targeted stimulation to specific joints and/or muscles. For example, the network of flexible cells may cause a distribution of different pressures placed by the material on the underlying tissue, where the pressures may vary from one part of the material to another. Such variations may be caused by, for example, the materials and particular structures of the network of flexible cells as described herein. The material provides a biomimetic design configured to deliver precise compression and weighting to target portions of a user. The biomimetic design includes a cell-pack configured to provide unique compression similar to that provided by a human circulation system. The combination of biomechanics and fluid mechanics facilitated by the garment is configured to provide precise location of forces to stimulate recovery of underlying physiological elements, such as joints and muscles.

In some embodiments, the material includes a liquid and/or gel weighted material that is contained within a supporting fabric. The supporting fabric and the liquid/gel weighted material provide an array of functional cell packs with a fluid component (e.g. hydrogel) enclosed therein. The cell pack can be made of an elastic stretchable polymer (i.e., elastomer), consisting of a network of hexagonal (in one non-limiting embodiment) compartments that contain the working fluid, connected via channels. The channels may be fibrous. In some embodiments, the material is configured to mimic a smart biological system that changes flow patterns and pressure distribution to handle the demand imposed by the task in which the user is engaged. In some embodiments, the supporting fabric includes spandex, although it will be appreciated that any suitable supporting fabric may be used.

In some embodiments, the array of functional cell packs provides a compression/stimulation mechanism that is analogous to a cardiovascular system, which actively modulates the heart rate and dilation levels in the relevant portions of the arterial tree, supplying the blood flow needs of specific muscle groups. Similarly, the material, using underlying contractions (e.g., muscle contractions) as an input signal, is configured to induce displacement of the compartments' flexible boundaries, initiating a local inter-compartmental flow, thereby building up local pressure as the fluid/gel attempts to move through the highly resistive channels. The channels may be fibrous. As fluid is displaced to other compartments, inner pressure within the array of functional cells increases due to elastic boundaries being stretched. In some embodiments, the increase in inner pressure propagates from a source compartment, mimicking a massage. The material may be configured to provide sufficient extra weight (for example, based on the inclusion of a fluid within the array of functional cell packs) needed for generating beneficial recovery-stimulating resistance, as well as compression and massage that are automatically targeted, for example, at one or more activated muscles in underlying the material.

In some embodiments, a material including a cell pack comprising a plurality of cells interconnected by a plurality of connecting channels is provided. The channels may be fibrous. The plurality of cells includes a working material configured to be transitioned from a first cell to at least a second cell when a compressive force is applied.

In some embodiments a material configured to provide therapeutic compression using a plurality of cell packs is provided.

In some embodiments, a material comprising a plurality of cell packs is provided.

In some embodiments, a method of providing therapeutic compression using a material including at least one cell pack is provided.

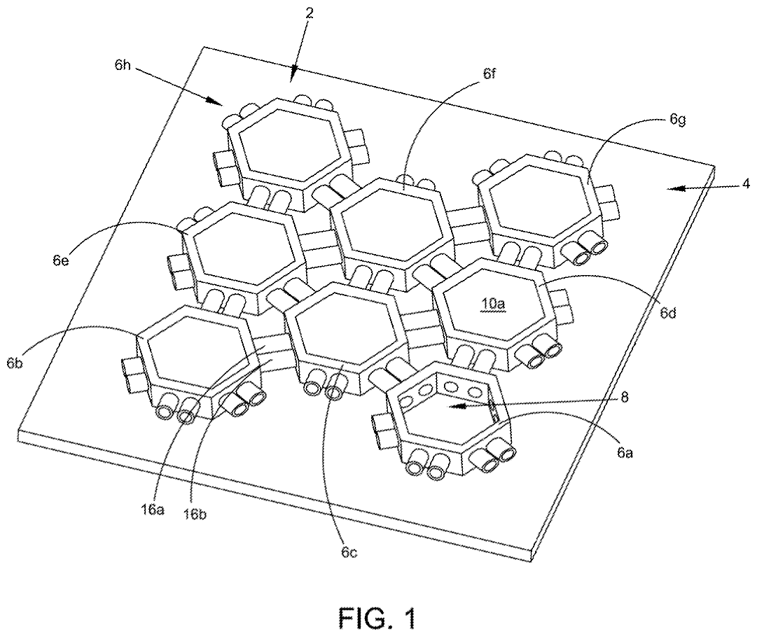

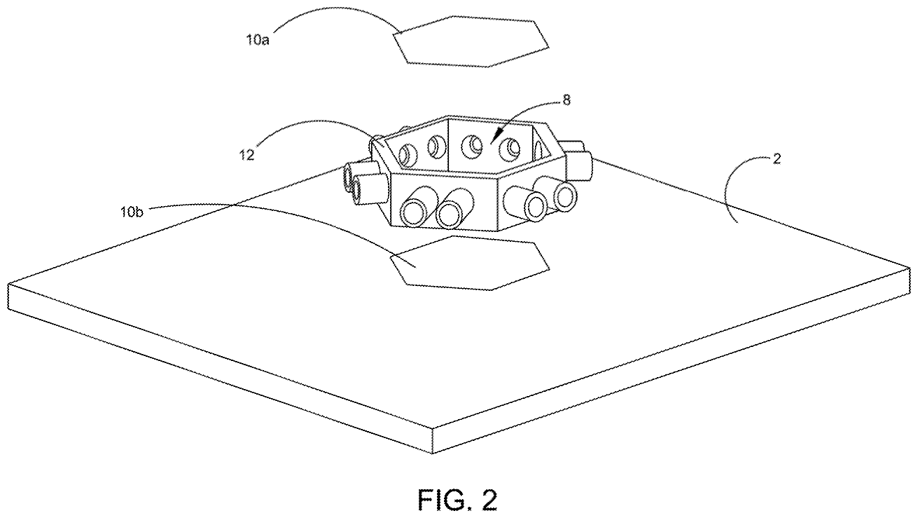

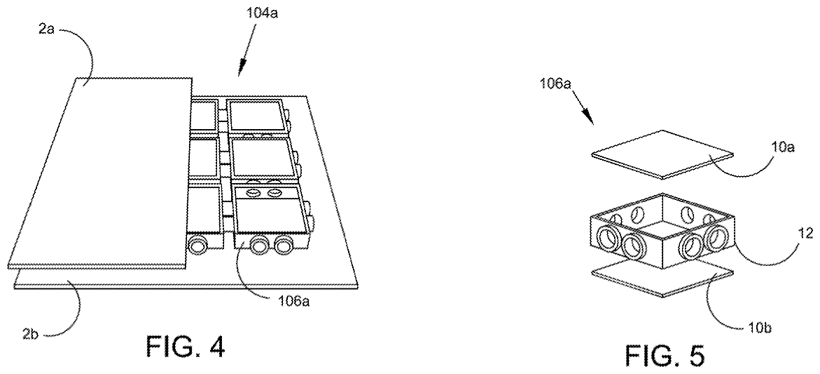

FIG. 1 illustrates a partial view of a portion of material 2 including a cell pack 4, in accordance with some embodiments. FIG. 2 illustrates an exploded view of a cell 6a of the cell pack 4, in accordance with some embodiments. The cell pack 4 includes a plurality of cells 6a-6h (collectively “cells 6”) that each defines an internal cavity 8. The cells 6 include an upper layer 10a, a lower layer 10b, and a perimeter wall 12 that collectively define the internal cavity 8. In some embodiments, one of the upper layer 10a and/or the lower layer 10b includes a material having a first (e.g., higher) elasticity and the perimeter wall 12 includes a material having a lower (e.g., lower/more rigid) elasticity. In some embodiments, one of the upper layer 10a and/or the lower layer 10b may be defined by a portion of the material 2, such as a fabric material, suitable for a material contained therein. In some embodiments, the internal cavity 8 is filled with a working material, such as a working fluid and/or gel. In some embodiments, the perimeter wall 12 may define any suitable shape, such as, for example, a hexagonal outer perimeter (as shown), a square outer perimeter (see FIG. 4), a circular perimeter, and/or any other suitable perimeter shape.

Each of the cells 6 is interconnected by one or more connecting channels 16a, 16b (collectively “connecting channels 16” or “channels 16”). The channels may be fibrous. The connecting channels 16 may be formed of the same material (described below) as the perimeter wall 12 of each of the cells 6. In some embodiments, the connecting channels interlink, or knit together, the plurality of cells 6. When one or more of the cells 6 are compressed (e.g., squeezed), for example by a wearer flexing a muscle positioned beneath or adjacent to the respective portion of the fabric 2, pressure build-up displaces the fluid into adjacent cells 6 through the connecting channels 16. The force displacement/build-up of the working material provides therapeutic compression to one or more targeted muscle groups co-located with the fabric 2.

Due to the elastic nature of each cell 6, e.g., the elastic nature of the upper layer 10a and/or the lower layer 10b, the extra working material that is received in each of the cells 6 will raise pressure in those cells, while depressurizing the central compartment. The combined pressurization/depressurization is configured to propagate pressure, for example, giving the patient in contact with the material a feeling of a propagating pressure mimicking a massage. When the pressure is relaxed (e.g., when a muscle is relaxed), the pressure build-up in the adjacent cells 6 pushes the extra working material back into a central, depressurized cell 6, restoring initial equilibrium.

In some embodiments, the flow throughout the entire material 2, e.g., throughout the entire network of cell packs 4, may be simulated using computational fluid dynamics and/or as a first order approximation treating the network of cell packs 4 as a hemodynamic circuit where cells 6 act as capacitors, and the connecting channels 16 as resistors.

In some embodiments, each cell pack 4 may include one or more elastomeric materials, such as, for example, PDMS Sylgard® 184, Ecoflex™, etc. PDMS Sylgard® 184, a silicone elastomer, is available from Dow of the United States, and, and Ecoflex™ is available from Smooth-on, Inc. of the United States. All types of the Ecoflex™, e.g., Ecoflex™ 00-10, 00-20, 00-30, 00-31, etc., may be suitable. Ecoflex™ is a platinum-catalyzed silicone rubber. Sylgard® 184 may consist of different mixing ratio in various embodiments, such as 10:1, 15:1, or 30:1 (elastomer base:curing agent) of when forming the elastomer. In some embodiments, the Sylgard® 184 may have an elasticity modulus of between 1.3-3 MPa. In some embodiments, the Ecoflex™ may have an elasticity modulus of 0.05-0.125 MPa. The various material properties, such as the elasticity of modulus, can be varied in order to provide a particular targeted treatment.

The use of elastomeric materials provides tunable mechanical strength and surface properties to each of the cells 6. The properties of the elastomer (e.g., elastomeric material), such as elastic modulus, may be adjusted to change fluidic resistance and the pressure distribution across different cells 6. The surface properties of the elastomer also influence its attachment with the supporting fabric 2.

In some embodiments, the elastic modulus of an elastomer material, such as Sylgard 184 or Ecoflex, is controlled by a ratio between a monomer and a curing agent. In some embodiments, the composition of the working material, such as a hydrogel, may be selected to further adjust the properties of an elastomer with respect to the geometry of the functional cell pack 4 to affect pressure redistribution within the cell pack 4 when stimulated by muscle contraction. In some embodiments, the surface properties of an elastomer (e.g., a polymer) can be selected to provide adhesion between the functional cell pack 4 and the supporting fabric 2.

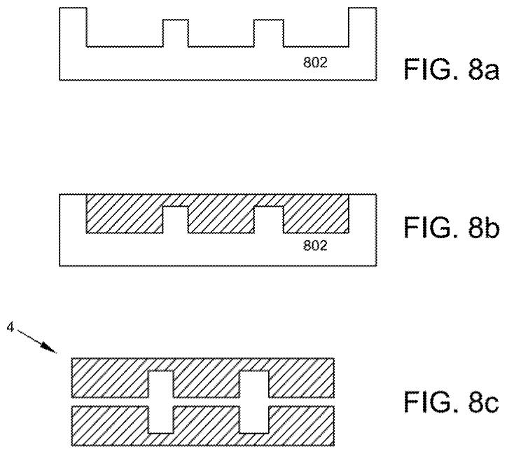

In some embodiments, a garment may include a material 2 may be manufactured by bringing together two halves of a cell pack 4 that are joined together, such as that described below with respect to FIGS. 8a-8c. Each half of the cell pack 4 may be formed through any suitable method, such as, for example, cast molding. In some embodiments, oxygen plasma treatment may be used to activate jointing surfaces. In other embodiments, fresh elastomers may be used as glue to join the two half pieces to define a full garment.

FIGS. 8a-8c illustrate an apparatus and process for molding/forming the cell pack 4 in accordance with some embodiments. The molding may begin with a mold 802 that has been appropriately shaped to create the cell pack 4 required. In other words, the size of the internal cavity 8, shape of the cells 6, number and shape of the channels 16 are determined by the mold. Next, the appropriate compounds/materials are put into the mold and cured, as is known in the art, to form one half of the cell pack 4, as shown in FIG. 8b. Once the two-halves of the cell pack 4 are formed and removed from the mold 802, as shown in FIG. 8c, they may be joined together as described herein. In some embodiments, the size of each of the cells 6 and/or the connecting channels 16 can be varied. In some embodiments, the diameter of each of the connecting channels 16 may be sized from about 0.3 mm to about 3 mm. The size of the connecting channels 16 may be selected to control flow resistance across the connecting network. In some embodiments, a surface of an elastomer can be modified using an oxygen plasma process to tailor adhesion with the supporting fabrics.

In some embodiments, the molding/forming of the cell pack 4 may be an iterative process. For example, portions of the cell pack 4 having common composition may formed at the same time. Once that portion has cured, other portions of the cell pack 4 having different properties or made of different materials may be formed and allowed to cure. Other processes may be used to form the cell pack 4 such that it is made of different materials and/or has varying processes, for example, using 3D printing.

In some embodiments, each of the cells 6 and/or the connecting channels 16 may be formed by a 3D printing process. For example, the cells 6 and/or the connecting channels 16 may be formed directly by 3D printing. As another example, a 3D printing mold may be generated using any suitable additive manufacturing process, such as, for example, a QIDI Technology Dual head 3D printer available from QIDI Technology of China.

In various embodiments, the dimensions of the cell pack 4 are selected to provide predetermined fluidity, viscosity, and/or applied pressures. The viscosity may be selected to provide a Newtonian or non-Newtonian response. In some embodiments, a non-Newtonian response and resistance to temperature change are provided by a bio-safe hydrogel, or slime. For example, in some embodiments, a working material may include a material having water, polyvinyl alcohol, borax, e.g., Na₂B₄O₇·10H₂O, or any other fluid of suitable viscosity for the desired resistance to flow, e.g., glycerin, lubricating oil, etc. A non-exhaustive range of viscosities includes 0.85-954 mPa-s where, again, the various material properties, can be varied in order to provide a particular targeted treatment through designed fluid flow and distribution of pressures across a cell pack 4. For example, water may have a viscosity of between 0.85-0.95 mPa-s and, e.g., Glycerin 954 mPa-s.

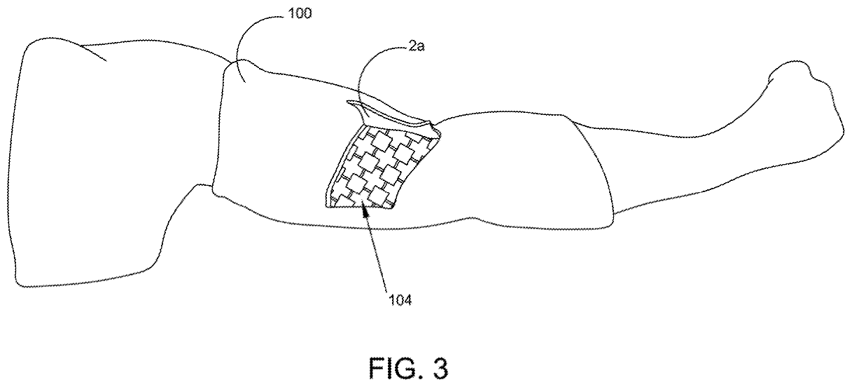

FIG. 3 illustrates an embodiment of wearable garment 100 configured for positioning over a user's limb, for example, an upper arm (e.g., bicep, triceps, etc.) and elbow joint. In embodiments, the wearable garment 100 may be a sleeve. A portion of an upper layer 2a of the garment 100 is removed to illustrate the cell pack network 104 therein. The cell pack network 104 includes a plurality of cell packs 4 similar to the cell packs 4 and cells 6 discussed above with respect to FIGS. 1-2 (and elsewhere), and similar description is not necessarily repeated here. FIG. 4 illustrates a portion of the cell pack network 104 and FIG. 5 illustrates an exploded view of one cell 106a of the cell pack network 104, in accordance with some embodiments. The cell pack network 104 and the cell 106a are similar to the cell pack 4 and cells 6 discussed elsewhere, and similar description is not repeated here.

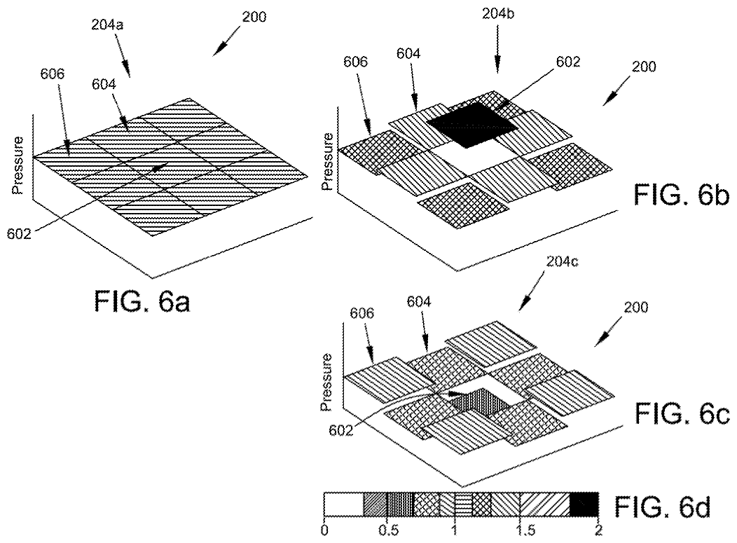

FIGS. 6a-6c illustrate representative pressures of a 3×3 cell pack 200 during use, in accordance with some embodiments. FIG. 6d illustrates a key of various pressures range from lowest (left) to highest (right). FIGS. 6a-6c indicate transitions between various pressure states, for example, due to movement of a muscle or compression of various cells within the 3×3 cell pack. In some embodiments, FIGS. 6a-6c illustrate a chronological transition of a garment including the 3×3 cell pack 200. As shown in FIG. 6a, in some embodiments, the 3×3 cell pack 200 starts in a neutral state 204a before a central cell 602 is compressed, increasing pressure within the cell 602 as illustrated by FIG. 6b. This pressure increases in cell 602 and causes the working material within the cell 602 to move to the surrounding cells, e.g., cells 604 and 606, causing the cell pack 200 to be in state 204b. Upon release of the force that compressed cell 602, pressure in the other cells, for example 604 and 606, may cause the flow of the working material back to cell 602. In some embodiments, if cell 602 is expanded by, for example, adherence to a moving subject, this may create a negative pressure in cell 602 relative to the adjacent cells, shown in state 204c of FIG. 6c. When compression is removed from the central cells 602, the vacuum within the central cell 602 causes the working material to flow back into the central cell 602, returning the cell pack 200 to an equilibrium, or neutral, state 204a of FIG. 6a.

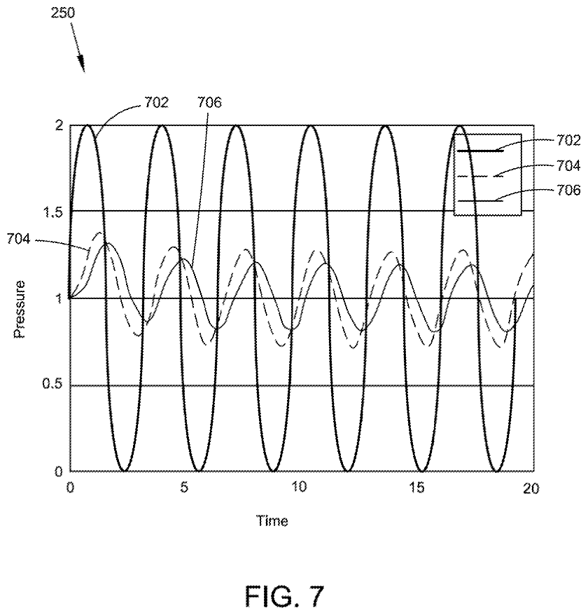

FIG. 7 is a graph illustrating the change in pressure over time of various cells 602 to 606 during repeating movement, with lines 702, 704 and 706 corresponding to the cells 602, 604 and 606, respectively.

The disclosed material may be used in methods of continuous stimulation for assisting in physical recovery, according to some embodiments. A user, such as a patient involved in physical therapy, a patient recovering from a muscle pull, an athlete looking for additional resistance training, etc., may be instructed to wear a garment including a material having one or more cell packs, for example, including positioning of one or more tightly-fitting sections around selected muscle and/or joint locations. As the user engages in activities, such as normal movement during the day, the material, and specifically the cell packs, exerts targeted compressive force on the predetermined portions of the body (e.g., joints, muscle groups, etc.) that stimulates recovery.

In some embodiments, the disclosed material may be formed using a hybrid manufacturing process, including, but not limited to, cast molding, 3D printing and plasma treatment, configured to generate a network of flexible cells filled with a viscous Newtonian or non-Newtonian fluid. The network of flexible cells provides tunable fluid dynamics and responsive material designed to aid in recovery and stimulation of targeted physiological features.

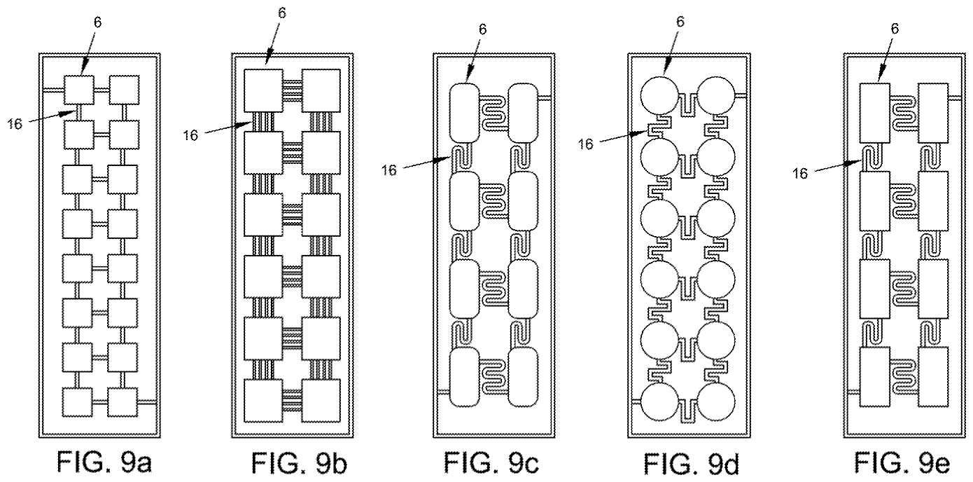

In various embodiments, cell pack 4 may comprise the required shaped (round, square, rectangular, etc.), number, distribution (e.g., a rectangular grid with 10-20 mm cell spacing, staggered over a, e.g., 150-250 mm×50 mm cell pack, including sizes of 150×50 mm (particularly useful for artificial muscles), 190×50 mm, 200 mm×50 mm, and 250 mm×50 mm), and size of both cells 6 (e.g., 5-8 mm radius, 10-20 mm in length/width for rectangular and square shapes, including 15×15 mm, and 10×20 mm seizes, using a depth of between 1-2 mm for any shape) and channels 16 (e.g., 1-5 between cells having a total length between 25-55 mm, using, e.g., a 1×1 mm cross-section for square shapes and 0.5 mm radius for round shapes) in order to provide the required, targeted stimulation to the subject. In one example, a channel diameter of 1 mm was used with cell spacing of 10 mm on a short-side pitch and 20 mm on the long side pitch, with cells of 2 mm height and a volume of 157.5 mm³. These characteristics, along with the particular materials, may be designed to control the effective fluidic resistance of the cells 6, both as a group and individually, thereby increasing or decreasing the pressure required for the working material to flow between cells or particular cell. These variable pressures in turn result in varying pressures delivered to different locations on the subject. Various embodiments that may have these characteristics are shown in FIGS. 9a to 9e that illustrate the mold 802, that may be 3D printed, used to form the cell pack 4. For example, FIGS. 9a to 9b illustrate square cells 6 each with either one or three channels 16 connecting them, respectively. FIG. 9c illustrates an elongated cell 6, which may be substantially rectangular and/or ovoid in shape, with rounded, serpentine channels 16, where the tortuous fluid path created by the many extensions and returns may increase the resistance to fluid flowing from one cell 6 to another. FIG. 9d illustrates yet another shape for both cell 6 and channel 16. For example, the cell 6 may be substantially spherical or, as viewed, a cylinder extending into and out of the page. Channels 16 may also be serpentine, like the channels 16 of FIG. 9c, albeit with squared corners. As illustrated in FIG. 9e, cells 6 may be cuboid and/or, as viewed, a cylinder with its height running from the bottom to the top of the page.

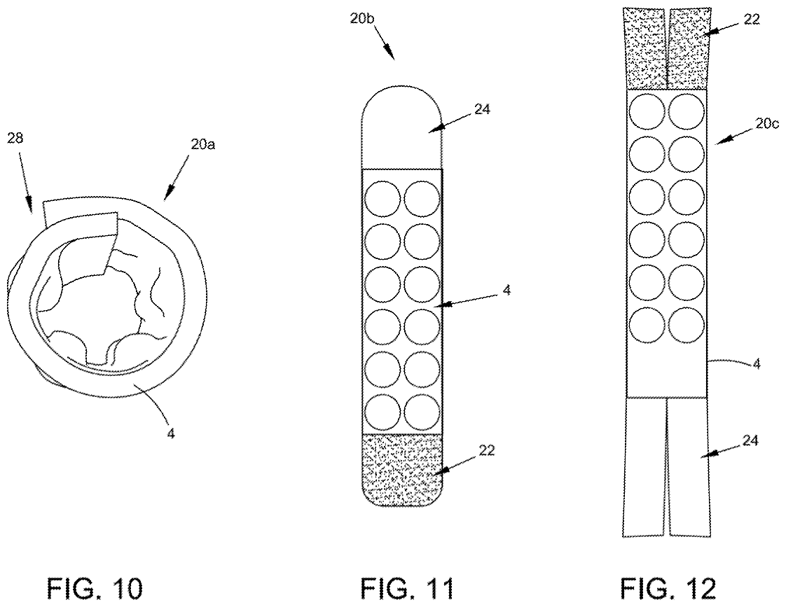

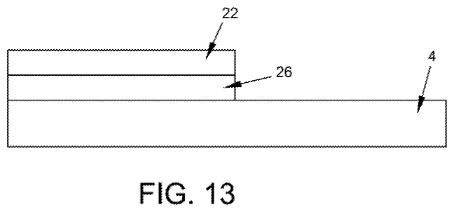

FIGS. 10-12 illustrate various embodiments for securing a cell pack 4 in shape such that it may envelop, or wrap, a portion of a subject in accordance with some embodiments. For example, the device 20a of FIG. 10 shows the cell pack 4 folded over and secured to itself at location 28 using glue or other fusing technique described herein or otherwise known to a person of ordinary skill. As shown in FIG. 11, device 20b uses hooks 22 and loops 24 coupled to the cell pack 4 for the releasable securing the cell pack 4 in the desired shape and orientation, for example, wrapping around an extremity of a user. Device 20c of FIG. 12 is yet another design incorporating hooks 22 and loops 24, albeit with two separate sections to provide increased angles and directions in which the device 20c may be secured in the desired shape. As illustrated in FIG. 13, the hook 22 (or loops 24, not shown) may be attached to the cell pack 4 via a fabric iron patch 26, which may provide for a more robust and effective coupling and between the cell pack 4 and hooks 22 (or loops 24) when cell pack 4 is composed of materials such as those described herein. Each of these embodiments may be paired with the fabric material 2 cover all or a portion of the cell pack 4 as described earlier.

Although the subject matter has been described in terms of various embodiments, the disclosure should be construed broadly, to include other variants and embodiments, which may be made by those skilled in the art in light of the teachings disclosed herein.

What is claimed is:

1. A device for providing a therapeutic stimulus to a subject, comprising:
a material configured to cover a portion of the subject, the material having an inner surface for engaging a surface of the subject and an exterior surface facing away from the surface of the subject;
a network of flexible cells coupled to the material, each flexible cell having an internal cavity;
at least one channel; and
a working material disposed within the internal cavities of the flexible cells;
wherein the at least one channel is arranged to allow exchange of the working material between flexible cells due to application of force upon the network from movement of the surface of the subject.

2. The device of claim 1, wherein at least one cell of the flexible cells comprises:
a perimeter wall proximate to and extending away from the exterior surface of the material;
an inner layer proximate to the exterior surface of the material and coupled to the perimeter wall; and
an outer layer substantially parallel to the inner layer and displaced from the inner layer by the wall, the outer layer coupled to the perimeter wall;
wherein the wall, the inner layer, and the outer layer define the internal cavity of the at least one cell.

3. The device of claim 2, wherein the perimeter wall of the at least one cell forms a hexagon.

4. The device of claim 2, wherein the perimeter wall of at least other cell of the plurality of cells is less elastic than the inner layer of the at least one cell.

5. The device of claim 1, wherein the device is configured to interface with a predetermined portion of the subject.

6. The device of claim 1, wherein the device is customized to interface with a predetermined portion of the subject.

7. The device of claim 1 configured to provide targeted stimulation to a specific portion of the subject using a varying fluidic resistance among the network of flexible cells or the at least one channel.

8. The device of claim 1, wherein the material is configured to be tightly fit against the portion of the subject.

9. The device of claim 1, wherein the portion of the subject is an extremity or joint of the subject.

10. The device of claim 1, wherein the working material is fluid or gel.

11. The device of claim 1, wherein the working material comprises hydrogel or composition comprising water, polyvinyl alcohol, and borax.

12. The device of claim 1, wherein the working material is a non-Newtonian fluid.

13. The device of claim 1, wherein more than one channel is coupled to and extends from a first cell of the network of flexible cells to a second cell of the network of flexible cells.

14. The device of claim 1, wherein at least one flexible cell of the network of flexible cells has a strength that is different from a strength of another flexible cell of the network of flexible cells.

15. The device of claim 1, wherein at least one flexible cell of the network of flexible cells comprises an elastomer.

16. The device of claim 1, comprising at least two channels wherein at least one of the channels has a size that is different than the size of another of the channels.

17. The device of claim 1, wherein the size of at least one cell of the network of flexible cells is different from the size of another of the cells of the network of flexible cells.

18. A therapeutic garment, comprising:
a plurality of cells, each cell comprising:
a perimeter wall;
an inner layer configured to be placed proximate to a subject; and
an outer layer substantially parallel to the inner layer and displaced from the inner layer by the wall;
wherein the wall, inner layer, and outer layer define an internal cavity;
a plurality of channels, each channel coupling the internal cavity of one cell of the plurality of cells to the internal cavity of another cell of the plurality of cells; and
a working material disposed in the internal cavity of at least one of the plurality of cells and the plurality of channels;
wherein the plurality of cells, plurality of channels, and working material form a cell pack.

19. The garment of claim 18 configured to provide targeted redistribution of the working material within the cell pack.

20. A method for applying a therapeutic treatment to a subject, comprising:
attaching a therapeutic device to a portion of a surface of the subject, the therapeutic device comprising:
a material configured to engage a portion of the subject;
a network of flexible cells coupled to the material, each flexible cell having an internal cavity;
at least one channel; and
a working material disposed within the internal cavities of the flexible cells;
wherein the at least one channel is arranged to allow exchange of the working material between flexible cells due to application of force upon the network of flexible cells from movement of the surface of the subject.
